(19) United States
(12) Patent Application Publication
(10) Pub. No.: US 2026/0106157 A1
(43) Pub. Date: Apr. 16, 2026

(54) CONDUCTIVE COMPOSITE MATERIAL COMPRISING CARBON-BASED PARTICLES AND POLYMER PARTICLES, METHOD FOR MANUFACTURING THE SAME, POSITIVE ELECTRODE FOR LITHIUM SECONDARY BATTERY COMPRISING THE SAME, AND LITHIUM SECONDARY BATTERY COMPRISING THE SAME

(71) Applicants: Hyundai Motor Company, Seoul (KR); Kia Corporation, Seoul (KR); Research & Business Foundation Sungkyunkwan University, Suwon (KR)

(72) Inventors: Seung-Min Oh, Hwaseong (KR); Sanghun Lee, Hwaseong (KR); Eungju Lee, Hwaseong (KR); Seungmin Hong, Suwon (KR); Dongjun Moon, Suwon (KR); Junmyoung Sheem, Suwon (KR); Young-Jun Kim, Seongnam (KR); Hyeongjun Choi, Suwon (KR)

(21) Appl. No.: 19/046,185

(22) Filed: Feb. 5, 2025

(30) Foreign Application Priority Data
Oct. 15, 2024 (KR) 10-2024-0140277

(51) Int. Cl. H01M 4/62; H01M 4/02; H01M 4/13

(52) U.S. Cl. CPC H01M 4/625; H01M 4/13; H01M 4/622; H01M 4/623; H01M 2004/028

(57) ABSTRACT

A method for manufacturing a conductive composite material involves ionizing carbon-based particles to have a first charge and polymer particles to have a second charge opposite to the first charge. The carbon-based particles are dispersed in a first solvent with an anionic surfactant, and the polymer particles are dispersed in a second solvent with a cationic surfactant. The method includes mixing the dispersions, separating the composite product, and drying it. The conductive composite material comprises carbon-based particles and polymer particles forming chemical bonds, with the carbon-based particles surface-modified by the first surfactant and the polymer particles by the second surfactant. The material is used in a positive electrode for lithium secondary batteries, where the conductive composite material and the positive electrode active material are coated by a dry process. The carbon-based particles include carbon nanomaterials, and the polymer particles include fluoropolymers or acrylonitrile-based polymers.

### CROSS-REFERENCE TO RELATED APPLICATION

This present application claims under 35 U.S.C. § 119(a) the benefit of Korean Patent Application No. 10-2024-0140277, filed on Oct. 15, 2024, in the Korean Intellectual Property Office, the entire disclosure of which is incorporated herein by reference.

### BACKGROUND

### Technical Field

The present disclosure relates to a conductive composite material comprising carbon-based particles and polymer particles and a method for manufacturing the same, and more particularly, to a conductive composite material comprising carbon-based particles and polymer particles having opposite charges and a method for manufacturing the same.

### Background

A lithium secondary battery is a device that stores energy by repeatedly charging and discharging while lithium ions electrochemically move between a positive electrode and a negative electrode. Key components that determine the performance of the lithium secondary battery may comprise a positive electrode active material, a conductive material, and a binder. These components may have a significant impact on the energy density, lifespan, stability, etc. of the battery.

A wet process is mainly used to manufacture the lithium secondary battery. In the wet process, polyvinylidene fluoride (PVDF) is mainly used as a binder. The PVDF serves to provide excellent chemical stability, mechanical strength, and thermal stability, and bond the positive electrode active material and the conductive material to the electrode well. The PVDF is mainly dissolved in an organic solvent called N-methyl-2-pyrrolidone (NMP) to make slurry, and the slurry is coated on a metal current collector and then dried to manufacture an electrode. In the wet process, carbon black is mainly used as the binder. Carbon black provides unique electrical conductivity to allow the active material to smoothly transfer electrons. In the electrode, the conductive material is evenly dispersed between active material particles to form a conductive network, which plays an important role in the electrical performance of the battery. Meanwhile, the wet process is currently widely used commercially but has several problems. In particular, since the NMP solvent is toxic, there is a disadvantage in that an additional process for removing the NMP solvent is required, and it takes a very long time to dry the current collector coated in the form of the slurry. Accordingly, the disadvantage may cause increased costs in large-scale production processes.

Therefore, interest in drying processes is increasing to solve the disadvantage. The dry process has an advantage of having less environmental burden without using the solvent and reducing the time and cost through process simplification. In the dry process, the binder and the conductive material play very important roles. Since there is no solvent as in the wet process, the binder plays a more direct role in mechanically binding the conductive material and the active material, and at the same time, interaction with the conductive material that affects electrical and thermal performance is essential. In order to manufacture an effective electrode in the dry process, the binder and the conductive material need to be uniformly mixed at an optimal ratio, which maximizes mechanical bonding strength with active material particles while also securing electrical performance. Therefore, research is ongoing on the binder and the conductive material that may be used in the dry process, and furthermore, a composite material mixed with the binder and the conductive material.

### SUMMARY

The present disclosure was created to solve the above-described problems in the related art, and an aspect of the present disclosure is to provide a conductive composite material having low electrical resistance, excellent chemical resistance, and applicability to a dry process, comprising both a conductive material and a binder having opposite charges, and a method for manufacturing the same.

In order to achieve the aspect, the present disclosure provides a method for manufacturing a conductive composite material comprising a first ionization step of ionizing carbon-based particles to have a first charge and a second ionization step of ionizing polymer particles to have a second charge having an opposite charge to the first charge.

According to an example of the present disclosure, the conductive composite material may comprise carbon-based particles having a first charge and polymer particles having a second charge having an opposite charge to the first charge, in which the carbon-based particles and the polymer particles may form chemical bonds.

According to the present disclosure, the conductive composite material may have excellent chemical resistance and low electrical resistance by complexing polymer particles with carbon-based particles.

According to the present disclosure, in the conductive composite material, carbon-based particles may be evenly dispersed between the polymer particles.

An electrode comprising the conductive composite material according to the present disclosure may have excellent rate characteristics. In addition, the electrode density may be excellent.

The conductive composite material according to the present disclosure may secure high powder conductivity by having a lower content of conductive carbon materials compared to existing technologies and may be economical.

The conductive composite material according to the present disclosure can reduce carbon emissions during the process by using an eco-friendly solvent.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a process diagram briefly illustrating a method for manufacturing a conductive composite material according to the present disclosure;

FIG. 2 is a graph showing powder resistance according to Experimental Example 1-1;

FIG. 3 is a graph showing rate characteristics according to Experimental Example 1-1;

FIG. 4 is a graph showing powder resistance according to Experimental Example 1-2;

FIG. 5 is a graph showing rate characteristics according to Experimental Example 1-2;

FIG. 6 is a result graph according to Experimental Example 1-4, in which FIG. 6A is a graph showing Hioki electrode resistance and FIG. 6B is a graph showing discharge rate characteristics;

FIG. 7 is a SEM image for Example 1;

FIG. 8 is a graph showing XRD analysis results for Example 1;

FIG. 9 is an image showing SEM images and EDS analysis results for Example 2;

FIG. 10 is an image showing SEM images and EDS analysis results for Comparative Example 1;

FIG. 11 is a graph showing powder resistance according to Experimental Example 3;

FIG. 12 is a graph showing rate characteristics according to Experimental Example 3;

FIG. 13 is a graph showing cycle characteristics according to Experimental Example 3;

FIG. 14 is a graph showing 4-terminal resistance measurement results according to Experimental Example 3;

FIG. 15 is a graph showing Hybrid Pulse Power Characterization (HPPC) measurement results according to Experimental Example 3;

FIG. 16 is a diagram showing resistance characteristics of electrodes of Example 2 and Comparative Example 1 according to Experimental Example 3, in which FIG. 16A is an EIS analysis result graph, FIG. 16B is a graph showing classifying electrolyte resistance, charge transfer resistance, and film resistance, and FIG. 16C is a graph showing ionic resistance; and

FIG. 17 is a graph showing capacity retention rate and coulombic efficiency according to Experimental Example 3.

### DETAILED DESCRIPTION

All terms used herein comprising technical or scientific terms have the same meanings as meanings which are generally understood by those skilled in the art unless they are differently defined. Terms defined in generally used dictionary shall be construed that they have meanings matching those in the context of a related art and shall not be construed in ideal or excessively formal meanings unless they are clearly defined in the present application.

As used in the present disclosure, the terms comprising as first, second, and the like are used for describing various constituent elements, but the constituent elements are not limited by the terms. These terms are only used to distinguish one component from another component. For example, without departing from the scope of the present invention, a first component may be named as a second component, and similarly, a second component may be named as a first component.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Terms used in the present disclosure are used only to describe specific examples and are not intended to limit the present disclosure. A singular expression comprises a plural expression unless the context clearly indicates otherwise. In the present disclosure, it should be understood that term “comprising” or “having” indicates that a feature, a number, a step, an operation, a component, a part or the combination thereof described in the specification is present, but does not exclude a possibility of presence or addition of one or more other features, numbers, steps, operations, components, parts or combinations thereof, in advance.

Hereinafter, a method for manufacturing a conductive composite material of the present disclosure will be described.

The method for manufacturing the conductive composite material of the present disclosure may comprise a first ionization step of ionizing carbon-based particles to have a first charge and a second ionization step of ionizing polymer particles to have a second charge having an opposite charge to the first charge.

In the first ionization step, a first dispersion may be prepared by dispersing the carbon-based particles and a first surfactant in a first solvent. The carbon-based particles may be a powder form, and in another example, may be a solution in which the carbon-based particles are dispersed. In one example, the carbon-based particles and the first surfactant may be dispersed in the first solvent by stirring at a rotation speed of 100 to 100,000 rpm.

In the second ionization step, a second dispersion may be prepared by dispersing the polymer particles and a second surfactant in a second solvent. The polymer particles may be a powder form, and in another example, may be a solution in which the polymer particles are dispersed. In one example, the polymer particles and the second surfactant may be dispersed in the second solvent by stirring at a rotation speed of 100 to 100,000 rpm.

In one example of the present disclosure, the first charge may be a negative charge, and the second charge may be a positive charge.

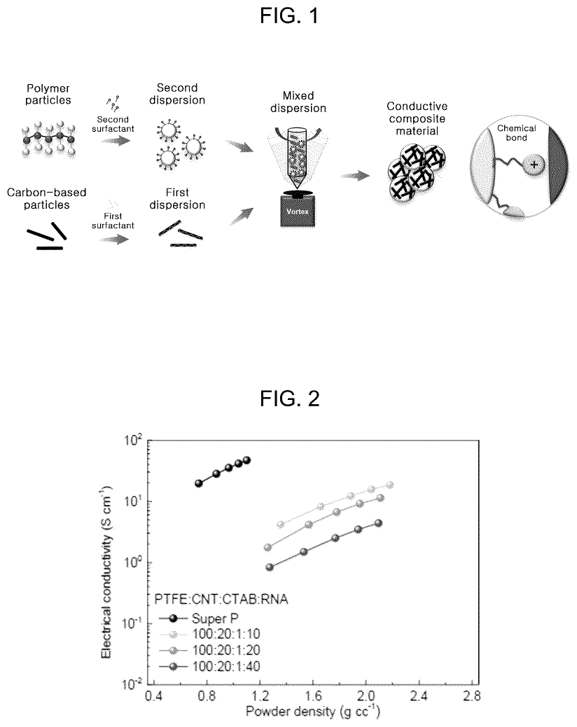

Hereinafter, the method for manufacturing the conductive composite material of the present disclosure will be described with reference to FIG. 1 by exemplifying a case where the first charge is a negative charge, and the second charge is a positive charge. Meanwhile, it is only one example, and the first charge may be a positive charge, and the second charge may be a negative charge.

FIG. 1 is a process diagram briefly illustrating a method for manufacturing a conductive composite material according to the present disclosure. Meanwhile, the particles or devices in FIG. 1 are only one example, and are not limited to the shapes, numbers, types, etc. of the particles or devices shown in FIG. 1.

Referring to FIG. 1, in the present disclosure, the first surfactant may be an anionic surfactant, and the second surfactant may be a cationic surfactant. The anionic surfactant may have a portion that exhibits surfactant activity when ionized in an aqueous solution, which has a negative charge (−). The cationic surfactant may have a portion that exhibits surfactant activity when ionized in an aqueous solution, which has a positive charge (+).

In one example, the first surfactant may comprise any one selected from the group consisting of ribonucleic acid (RNA), carboxymethyl cellulose (CMC), sodium dodecyl sulfate (SDS), and sodium dodecyl benzene sulfonate (SDBS).

In one example, the second surfactant may comprise any one selected from the group consisting of cetyl trimethyl ammonium bromide (CTAB), dodecyl trimethyl ammonium bromide (DTAB), and tetradecyl trimethyl-ammonium bromide (TTAB).

That is, in one example of the present disclosure, the first dispersion may comprise the carbon-based particles and the first surfactant, which is the anionic surfactant, and the second dispersion may comprise the polymer particles and the second surfactant, which is the cationic surfactant. At this time, the surface of the carbon-based particle may be modified by the first surfactant to have a negative charge. In addition, the surface of the polymer particle may be modified by the second surfactant to have a positive charge.

In the present disclosure, the carbon-based particles may comprise carbon nanomaterials, which may be selected from the group consisting of carbon nanofibers (CNF), carbon nanotubes (CNT), graphene, fullerene, and combinations thereof, and the polymer particles may comprise fluoropolymers or acrylonitrile-based polymers, which may be polytetrafluoroethylene (PTFE) or polyacrylonitrile (PAN).

In the present disclosure, the first solvent and the second solvent may be water or an organic solvent. In one example, the water may be DI water. In the present disclosure, water may be used as a solvent, which may be eco-friendly, thereby reducing carbon emissions during the process.

Meanwhile, in the present disclosure, in the first ionization step, the carbon-based particles and the first surfactant may be dispersed in a weight ratio of 1:0.01 to 1:0.5. If the first surfactant exceeds the range, aggregation may occur, resistance may increase, and electronic conductivity may decrease. When the first surfactant is less than the range, the surface modification effect of the carbon-based particles may be minimal. Therefore, the range may be preferable.

In the present disclosure, in the second ionization step, the polymer particles and the second surfactant may be dispersed in a weight ratio of 1:0.01 to 1:0.1. If the second surfactant exceeds the range, aggregation may occur, resistance may increase, and electronic conductivity may decrease. When the second surfactant is less than the range, the surface modification effect of the polymer particles may be minimal. Therefore, the range may be preferable.

The method for manufacturing the conductive composite material according to one embodiment of the present disclosure may further comprise preparing a mixed dispersion by stirring the first dispersion and the second dispersion, separating a composite product from the mixed dispersion, and drying the composite product.

In the preparing of the mixed dispersion by stirring the first dispersion and the second dispersion, the carbon-based particles comprised in the first dispersion and the polymer particles comprised in the second dispersion may be stirred in a weight ratio of 0.1:1 to 0.5:1. If the carbon-based particles exceed the range, a fiberization space of the polymer particles may be obstructed, making it difficult to perform the separating of the composite product to be described below. If the carbon-based particles are less than the range, the effect in terms of conductivity may be minimal. Therefore, the range may be preferable.

In the preparing of the mixed dispersion, the carbon-based particles comprised in the first dispersion and the polymer particles comprised in the second dispersion may form chemical bonds. The chemical bonds may be any one selected from the group consisting of ionic bonds, π-π transition bonds, and hydrogen bonds.

The separating of the composite product from the mixed dispersion may be performed by centrifuging at 3,000 to 5,000 rpm. In addition, the centrifuging was performed for 3 to 10 minutes. The solvent comprised in the mixed dispersion may be removed through the centrifugation. The solvent may be a first solvent comprised in the first dispersion and a second solvent comprised in the second dispersion.

The composite product separated from the mixed dispersion may be in the form of powder.

The drying of the composite product may be performed at a temperature of −200 to 200° C. In addition, the drying may be performed under vacuum conditions.

In one example, the method for manufacturing the conductive composite material of the present disclosure may further comprise uniformizing the size of the composite product. At this time, the composite product particles may be crushed using a freeze crusher. However, this is only one example, and is not limited to any form, and the size of the composite product particles may be uniformized through a conventional crushing method.

Hereinafter, a conductive composite material of the present disclosure will be described.

The conductive composite material of the present disclosure may be manufactured according to the method for manufacturing the conductive composite material of the present disclosure described above.

The conductive composite material of the present disclosure may comprise carbon-based particles having a first charge and polymer particles having a second charge having an opposite charge to the first charge.

The carbon-based particle may be surface-modified by a first surfactant to have a first charge, and the polymer particle may be surface-modified by a second surfactant to have a second charge.

The first surfactant may be anionic surfactant. In one example, the first surfactant may comprise any one selected from the group consisting of ribonucleic acid (RNA), carboxymethyl cellulose (CMC), sodium dodecyl sulfate (SDS), and sodium dodecyl benzene sulfonate (SDBS).

The second surfactant may be a cationic surfactant. In one example, the second surfactant may comprise any one selected from the group consisting of cetyl trimethyl ammonium bromide (CTAB), dodecyl trimethyl ammonium bromide (DTAB), and tetradecyl trimethyl-ammonium bromide (TTAB).

That is, in one example, the carbon-based particles may be surface-modified by the first surfactant, which is an anionic surfactant, to have a first charge. In addition, the polymer particles may be surface-modified by the second surfactant, which is a cationic surfactant, to have a second charge.

In one example, when the first surfactant is the anionic surfactant, the first charge may be a negative charge. In addition, when the second surfactant is the cationic surfactant, the second charge may be a positive charge.

The carbon-based particles and the polymer particles having different charges as described above may form chemical bonds within the conductive composite material. At this time, the chemical bonds may be any one selected from the group consisting of ionic bonds, π-π transition bonds, and hydrogen bonds.

In the present disclosure, the carbon-based particles may comprise carbon nanomaterials, which may be selected from the group consisting of carbon nanofibers (CNF), carbon nanotubes (CNT), graphene, fullerene, and combinations thereof.

In the present disclosure, the polymer particles may comprise fluoropolymers or acrylonitrile-based polymers, which may be polytetrafluoroethylene (PTFE) or polyacrylonitrile (PAN). The polymer particles may be fiberized in a dry process. When fiberized, the carbon-based particles may be evenly dispersed between the fibers.

According to one example of the present disclosure, the carbon-based particles and the polymer particles may be mixed in a weight ratio of 0.1:1 to 0.5:1. If the carbon-based particles exceed the range, a fiberization space of the polymer particles may be obstructed. If the carbon-based particles are less than the range, the effect in terms of conductivity may be minimal. Therefore, the range may be preferable.

The positive electrode for the lithium secondary battery of the present disclosure may comprise a conductive composite material and a positive electrode active material according to various examples described above. The positive electrode active material may be used with a mixture of one or two or more lithium-containing transition metal oxides commonly used in the lithium secondary battery but is not necessarily limited thereto. As the lithium-containing transition metal oxide, for example, a composite oxide of lithium and cobalt, nickel, manganese, etc. may be used. In addition, the positive electrode composition may further comprise a positive electrode current collector. The positive electrode current collector may be used without limitation as long as it has good conductivity, may be easily coated with the positive electrode active material, and is non-reactive within a voltage range of the battery. Examples thereof may comprise, but are not limited to, aluminum (Al), nickel (Ni), etc.

In one example, the conductive composite material and the positive electrode active material may be dry-coated. That is, the positive electrode may be manufactured through a dry process. The dry process may be eco-friendly without using an environmentally harmful solvent compared to a wet process. In addition, the process may be simplified and economical in terms of time and cost.

The lithium secondary battery of the present disclosure may comprise the positive electrode, a negative electrode, and an electrolyte. The negative electrode may comprise a negative electrode active material and a negative electrode current collector. The negative electrode active material may comprise a carbon-based material. For example, the carbon-based material may comprise natural graphite, artificial graphite, soft carbon, hard carbon, etc., but is not limited thereto.

The current collector is not particularly limited as long as it has conductivity without causing a chemical change in the lithium-ion battery in the same manner as the positive electrode. For example, the current collector may be used with copper, stainless steel, aluminum, nickel, titanium, plastic carbon, copper or stainless-steel surface-treated with carbon, nickel, titanium, silver, etc., an aluminum-cadmium alloy, and the like.

The electrolyte may comprise a lithium salt. The lithium salt may act as a passage through which lithium ions may move, and may be used with LiPF6, LiBF4, LiBOB, LiTFSI, and the like, but is not necessarily limited thereto. In addition, the electrolyte may comprise a solvent and an additive, but is not limited to any one type, and any solvent and additive commonly used may be used.

Hereinafter, the present invention will be described in more detail with reference to Examples. However, the following Examples and Experimental Examples are only intended to describe the present disclosure in more detail, and the scope of the present disclosure is not limited by the following Examples and Experimental Examples.

### Example 1

In order to manufacture a conductive composite material according to the present disclosure, carbon nanotube (hereinafter, CNT) was used as carbon-based particles, and PTFE was used as polymer particles. In addition, ribonucleic acid (hereinafter, RNA) was used as a first surfactant, and CTAB was used as a second surfactant.

First, CNT (5 wt % solid content) and RNA were added to DI water, and dispersed through tip sonication to prepare a first dispersion. At this time, the weight ratio of CNT and RNA added was 2:1.

Thereafter, PTFE (60 wt % solid content emulsion) and CTAB were added to DI water and stirred by ultrasonication for 30 minutes and vortex for 5 minutes to prepare a second dispersion. At this time, the weight ratio of PTFE and CTAB added was 100:1.

The first dispersion and the second dispersion were mixed, added with additional DI water, and stirred with a vortex for 5 minutes. Thereafter, the solvent was removed by centrifugation at 4000 rpm for 5 minutes to obtain a composite product. Finally, the composite product was vacuum-dried at a temperature of 120° C. to obtain powder and the particles were crushed (uniformized into particles) with a freeze crusher to finally prepare a conductive composite material. The final weight ratio of PTFE and CNT was 100:20, and the overall weight ratio of PTFE:CNT:CTAB:RNA was 100:20:1:10.

### Example 2

A positive electrode for a lithium secondary battery comprising 98 wt % of a positive electrode active material NCMA, 1 wt % of the conductive composite material according to Example 1, and 1 wt % of an additional conductive material Super-P was manufactured through a dry process.

### Comparative Example 1

Unlike Example 2, a positive electrode for a lithium secondary battery was manufactured through a wet process. 96 wt % of NCMA was used as a positive electrode active material, 2 wt % of polyvinylidene fluoride (PVDF) was used as a binder, and 2 wt % of Super-P was used as a conductive material.

### Comparative Example 2

First, PTFE and CTAB in a powder form were added to an ethanol (EtOH) solution and then stirred. Then, ethanol was removed and dried to obtain cationized PTFE particles. At this time, the weight ratio of PTFE and CTAB added was 100:100.

Thereafter, a CB-ethanol dispersion was prepared using carbon black (CB) and RNA. The CB-ethanol dispersion and the PTFE particles were mixed, and then the solvent was removed by centrifugation at 4000 rpm. The powder obtained above was crushed (uniformized into particles) using a freeze crusher to finally manufacture a composite material. The final weight ratio of PTFE and CB was 100:100, and the overall weight ratio of PTFE:CB:CTAB:RNA was 100:100:100:50.

Finally, a positive electrode for a lithium secondary battery comprising 98 wt % of the positive electrode active material NCMA, 1 wt % of the composite material, and 1 wt % of the additional conductive material Super-P was manufactured through a dry process.

### Experimental Example 1

Hereinafter, a preferred composition range was confirmed by changing some conditions in the compositions of Examples 1 and 2.

### Experimental Example 1-1

### CNT/RNA Ratio

In Experimental Example 1-1, a conductive composite material with a different ratio of RNA to CNT in a first dispersion preparation step was prepared, and physical properties thereof were compared with those of the conductive composite material of Example 1.

Finally, conductive composite material samples with the weight ratios shown in Table 1 below were prepared, and the powder resistance was compared with that of Super-P. This was shown in FIG. 2. Meanwhile, FIG. 2 showed Examples and samples at composition ratios.

TABLE 1

| | Example 1 | Sample 1 | Sample 2 |
|---|---|---|---|
| Composition ratio | 100:20:1:10 | 100:20:1:20 | 100:20:1:40 |
| (PTFE:CNT:CTAB:RNA) | | | |

Referring to Table 1 and FIG. 2, it may be seen that the electronic conductivity decreases as the RNA content increases, and therefore, it may be inferred that the conductivity may be excellent when the RNA content is 1.0 times or less than that of CNT.

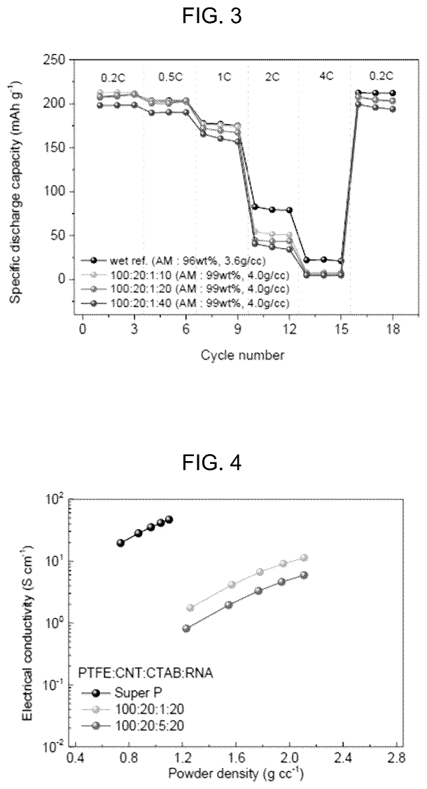

In addition, a positive electrode comprising 1 wt % of the conductive composite material sample and 99 wt % of the positive electrode active material NCMA with the weight ratios shown in Table 1 was manufactured, and the rate characteristics were compared with those of the positive electrodes of Example 2 and Comparative Example 1. This was shown in FIG. 3. In Experimental Example 1-1, the positive electrode of Example 2 comprised 99 wt % of the positive electrode active material NCMA and 1 wt % of the conductive composite material without comprising an additional conductive material. Meanwhile, in the graph of FIG. 3, AM represents the content of the active material, and 3.6 g/cc and 4.0 g/cc represent electrode densities. In addition, in FIG. 3, the positive electrode of Comparative Example 1 was represented as a wet ref., and Examples and samples were shown at composition ratios.

Referring to FIG. 3, it may be seen that the discharge rate characteristics by C-rate deteriorates when the RNA content increases, and through this, it may be inferred that the conductivity may be excellent when the RNA content is 0.5 times or less than that of CNT.

### Experimental Example 1-2

### PTFE/CTAB Ratio

In Experimental Example 1-2, a conductive composite material with a different ratio of CTAB to PTFE in a second dispersion preparation step was prepared and the physical properties thereof were compared with those of the conductive composite material of Example 1.

Finally, samples of conductive composite materials at weight ratios as shown in Table 2 below were prepared. Thereafter, the powder resistances of Super-P, Sample 1, and Sample 6 were compared. This was shown in FIG. 4. Meanwhile, FIG. 4 showed samples at composition ratios.

TABLE 2

| | Sample 3 | Sample 4 | Sample 5 | Sample 6 | Sample 7 |
|---|---|---|---|---|---|
| Composition ratio | 100:20:0.5:10 | 100:20:2:10 | 100:20:5:10 | 100:20:5:20 | 100:20:10:10 |
| (PTFE:CNT:CTAB:RNA) | | | | | |

Referring to Table 2 and FIG. 4, it may be seen that as the CTAB content increases, the resistance increases, and the electrical conductivity tends to decrease.

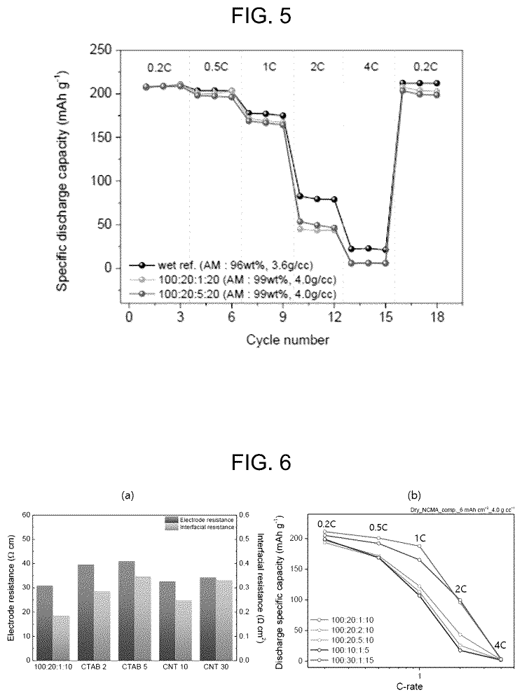

In addition, positive electrodes comprising 1 wt % of the conductive composite material sample and 99 wt % of the positive electrode active material NCMA with the weight ratios shown in Samples 1 and 6 were manufactured, and the rate characteristics were compared with those of the positive electrode of Comparative Example 1. This was shown in FIG. 5. Meanwhile, in the graph of FIG. 5, AM represents the content of the active material, and 3.6 g/cc and 4.0 g/cc represent electrode densities. In addition, in FIG. 5, the positive electrode of Comparative Example 1 was represented as a wet ref., and samples were shown at composition ratios.

Referring to FIG. 5, it may be seen that the capacity by C-rate deteriorates when the CTAB content increases, and through this, it may be inferred that the conductivity may be excellent when the CTAB content is 1 wt % with respect to PTFE.

In order to secure more comparison subjects, the conductive composite materials of Samples 3 to 5 and 7 in Table 2 were centrifuged. As a result, in the case of Sample 3, a small amount of separated composite product was obtained, which is determined to be due to a lack of CTAB required for chemical bonding. Therefore, it may be inferred that PTFE and CTAB preferably have a weight ratio of 1:0.01 to 1:0.1, and if the content of CTAB exceeds the range, byproducts are obtained and a decrease in physical properties may be expected.

### Experimental Example 1-3

### PTFE/CNT Ratio

In Experimental Example 1-3, conductive composite materials with different ratios of CNT to PTFE were prepared and the physical properties thereof were compared with those of the conductive composite material of Example.

As an additional condition, the ratio of CNT and RNA was set to 2:1, and then conductive composite material samples with weight ratios as shown in Table 3 below were prepared.

TABLE 3

| | Example 1 | Sample 8 | Sample 9 |
|---|---|---|---|
| Composition ratio | 100:20:1:10 | 100:10:1:5 | 100:30:1:15 |
| (PTFE:CNT:CTAB:RNA) | | | |

As another condition, the ratio of CNT and RNA was set to 1:1, and then conductive composite material samples with weight ratios as shown in Table 4 below were prepared.

TABLE 4

| | Example 1 | Sample 10 | Sample 1 | Sample 11 | Sample 12 |
|---|---|---|---|---|---|
| Composition ratio | 100:20:1:10 | 100:10:1:10 | 100:20:1:20 | 100:30:1:30 | 100:50:1:50 |
| (PTFE:CNT:CTAB:RNA) | | | | | |

As a result of centrifuging the conductive composite materials of Samples 1, and 8 to 12 in Tables 3 and 4, all samples were centrifuged as in Example 1, but there was a slight difference in the degree. For example, in the case of Sample 12, the separation of the composite product was not smooth, which may be determined to be due to the excessive CNT content. In addition, it was confirmed that the separation of the composite product was smoother when the ratio of CNT:RNA was 2:1 other than 1:1. Through this, it may be inferred that the conductivity may be excellent when the RNA content is 0.5 times or less than the CNT.

### Experimental Example 1-4

In Experimental Example 1-4, electrodes comprising composite materials of Sample 4, Sample 5, Sample 8, and Sample 9 were manufactured, and the Hioki electrode resistance was analyzed, and the discharge rate characteristics were evaluated together with the electrode of Example 2.

This was shown in FIG. 6. FIG. 6A is a graph showing the Hioki electrode resistance, and FIG. 6B is a graph showing the discharge rate characteristics. Meanwhile, FIG. 6A shows Examples at composition ratios, Sample 4 represented by CTAB 2, Sample 5 represented by CTAB 5, Sample 8 represented by CNT 10, and Sample 9 represented by CNT 30, and FIG. 6B shows Examples and samples at composition ratios.

Referring to FIG. 6A, it may be seen that the resistance increases as the CTAB content increases. In addition, it may be confirmed that there may be limitations in the formation of a uniform composite material when the CNT content decreases, and that the resistance may increase due to an increase in RNA content when the CNT content increases. In addition, referring to FIG. 6B, it was confirmed that the rate characteristics were superior in all sections in the case of Example 2.

### Experimental Example 2

### Morphology Observation

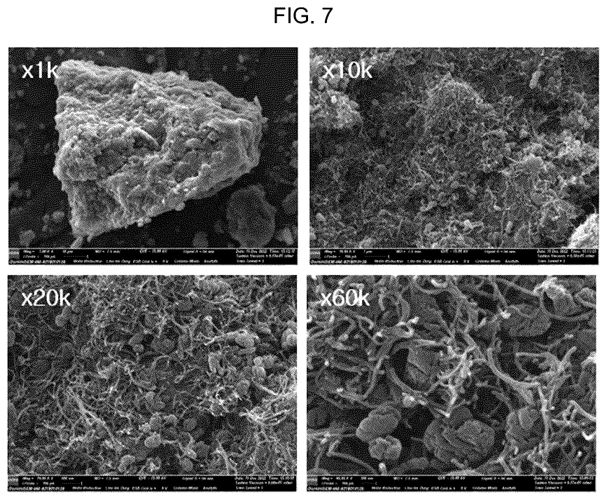

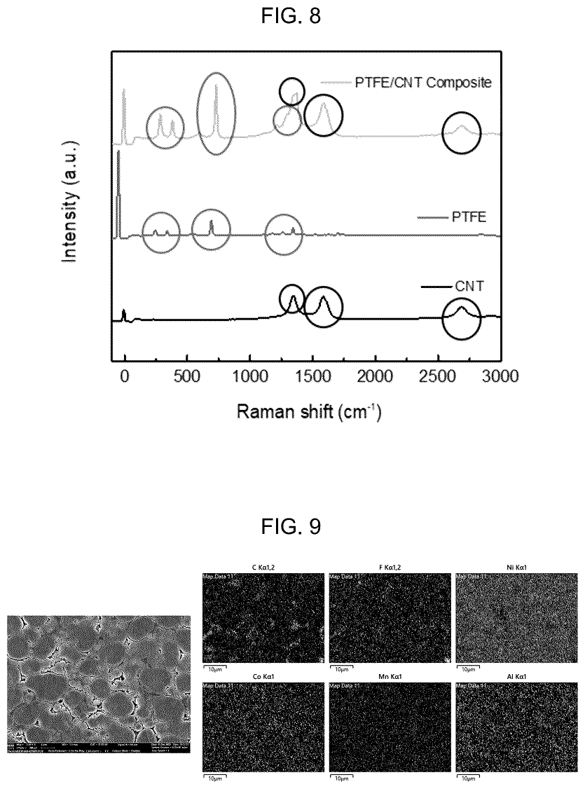

In Experimental Example 2, the morphology of the conductive composite material of Example 1 was observed. The SEM image for Example 1 was shown in FIG. 7 according to a magnification, and the XRD analysis results were shown in FIG. 8. Meanwhile, in FIG. 8, the conductive composite material of Example 1 was simply represented as PTFE/CNT Composite.

Referring to FIG. 7, it may be confirmed that in the conductive composite material of Example 1, PTFEs as polymer particles were fiberized, and CNTs as carbon-based particles were evenly distributed in a space therebetween. Referring to FIG. 8, the peaks that may be confirmed in each of PTFE and CNT are also confirmed in the conductive composite material of Example 1, and thus it may be seen that both PTFE and CNT coexist stably.

In addition, the positive electrode of Example 2 and the positive electrode of Comparative Example 1 were compared through SEM images and EDS analysis. FIG. 9 shows the SEM image and EDS analysis result of Example 2, and FIG. 10 shows the SEM image and EDS analysis result of Comparative Example 1.

Referring to FIGS. 9 and 10, in the case of Comparative Example 1, it may be seen through F Kα1,2 of the SEM image and EDS result that PTFEs were not well dispersed. In addition, it may be confirmed through C Kα1,2 of the EDS result that the carbon-based materials were aggregated around the PTFEs. On the other hand, in the case of Example 2, the aggregated PTFE or carbon-based material is not visible in the SEM image, and it may be seen that the PTFE or carbon-based material has been dispersed well in the EDS result.

Through this, it may be confirmed that in the positive electrode of Example 2 manufactured by the dry process, the carbon-based material, i.e., the conductive material was dispersed better.

### Experimental Example 3

### Electrochemical Characteristics

In Experimental Example 3, the electrochemical characteristics of the positive electrode according to Example 2 were evaluated through various experiments as follows.

### Powder Conductivity and Rate Characteristics

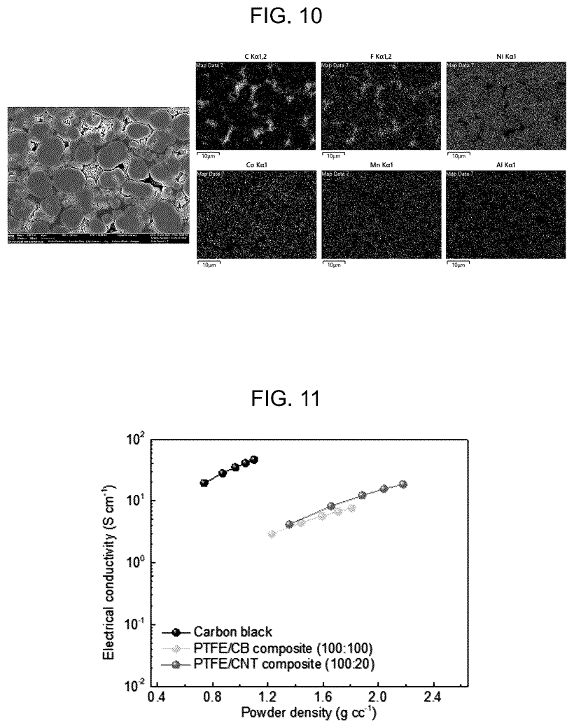

The powder conductivity was measured for the conductive composite material of Example 1, carbon black, and the conductive composite material comprised in Comparative Example 2. The results were shown in FIG. 11. Meanwhile, in FIG. 11, the conductive composite material of Example 1 was represented as a PTFE/CNT composite (100:20), and the conductive composite material comprised in Comparative Example 2 was represented as a PTFE/CB composite (100:100).

Referring to FIG. 11, it may be seen that the powder conductivity of Example 1 is high, and it was confirmed that high powder conductivity could be secured even though the weight of conductive carbon was relatively small.

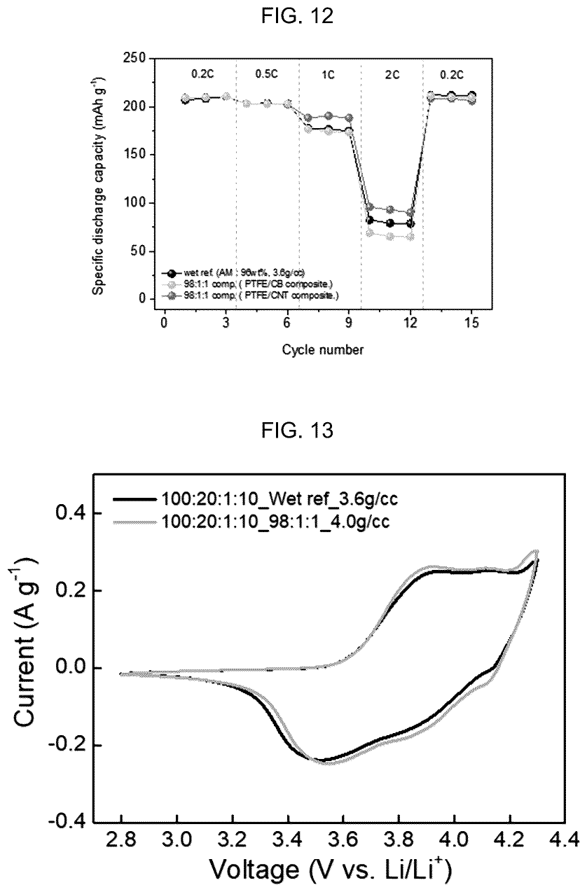

In addition, the rate characteristics of the batteries comprising the electrodes of Example 2, Comparative Example 1, and Comparative Example 2 were compared. The results were shown in FIG. 12. Meanwhile, in FIG. 12, the electrode of Comparative Example 1 was represented as wet ref., the electrode of Comparative Example 2 was represented as 98:1:1 comp. (PTFE/CB composite), and the electrode of Example 2 was represented as 98:1:1 comp. (PTFE/CNT composite).

Referring to FIG. 12, it may be confirmed that the rate characteristics of Example 1 are excellent in almost all sections, and in particular, it may be confirmed that Example 1 has excellent discharge rate characteristics even at high rates.

### Cycle Characteristics

The cycle characteristics were measured for the batteries comprising the electrodes of Example 2 and Comparative Example 1. The results were shown in FIG. 13. Meanwhile, in FIG. 13, the electrode of Example 2 was represented as 100:20:1:10_98:1:1_4.0 g/cc, and the electrode of Comparative Example 1 was represented as 100:20:1:10_Wet ref_3.6 gcc.

Referring to FIG. 13, in the case of Example 2, it may be confirmed that there is no side reaction by showing similar cycle characteristics to Comparative Example 1, and accordingly, it was confirmed that PTFE may not cause a side reaction with the electrolyte when forming an electrode. This may be inferred because the electrode of Example 2 was comprised not only with PTFE but also with CNT.

### Resistance Characteristics

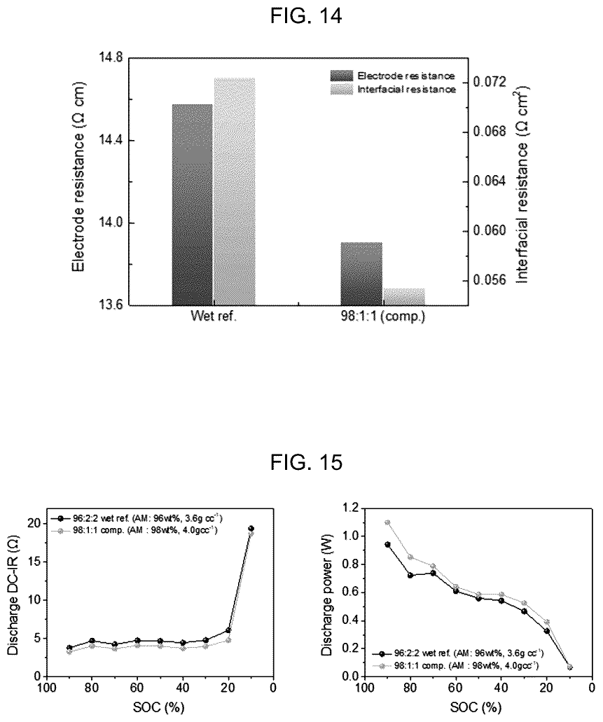

The resistance characteristics of the batteries comprising the electrodes of Example 2 and Comparative Example 1 were analyzed through 4-terminal resistance measurement and Hybrid Pulse Power Characterization (HPPC) measurement. The results were illustrated in FIGS. 14 and 15, respectively. Meanwhile, in FIG. 14, the electrode of Comparative Example 1 was represented as Wet ref., and the electrode of Example 2 was represented as 98:1:1 (comp.). In FIG. 15, the electrode of Comparative Example 1 was represented as 96:2:2 wet ref., and the electrode of Example 2 was represented as 98:1:1 comp.

Referring to FIG. 14, it may be seen that the resistance value at the electrode surface or interface of Example 2 is lower than that of Comparative Example 1. In addition, referring to FIG. 15, it may be seen that the resistance of Example 2 was measured to be lower than that of Comparative Example 1. Through this, it may be seen that the resistance of the electrode of Example 2 manufactured through a dry process is lower than that of the electrode of Comparative Example 1 manufactured through a wet process.

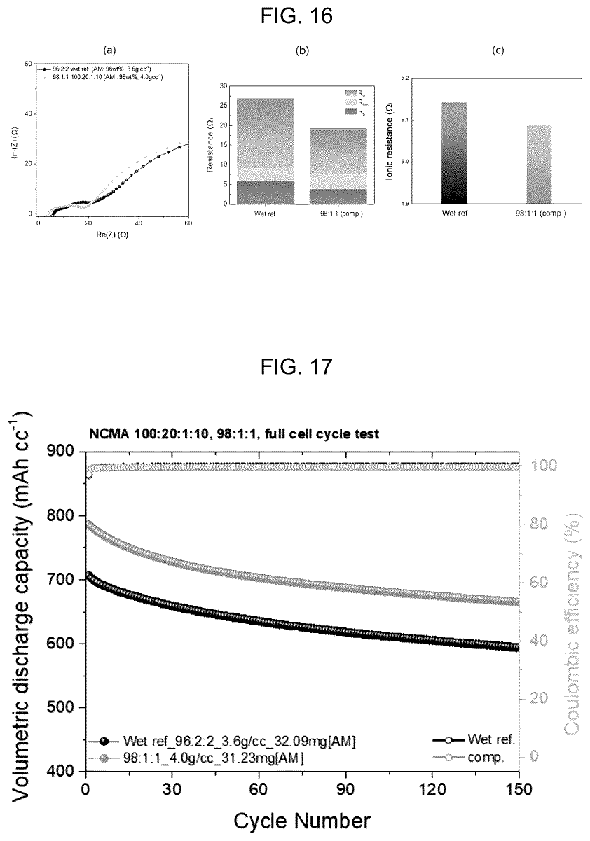

Next, electrochemical impedance spectroscopy (EIS) analysis was performed on the batteries comprising the electrodes of Example 2 and Comparative Example 1, and the results were shown in FIG. 16A. In FIG. 16A, the electrode of Example 2 was represented as 98:1:1 100:20:1:10, and the electrode of Comparative Example 1 was represented as 96:2:2 wet ref.

In addition, based on the analysis results, electrolyte resistance (bulk resistance, R_{b}), charge-transfer resistance (R_{ct}), and film resistance (R_{film}) were derived, which was shown in FIG. 16B. In FIG. 16B, the electrode of Example 2 was represented as 98:1:1 (comp.), and the electrode of Comparative Example 1 was represented as Wet ref.

In addition, the ionic resistance was derived and shown in FIG. 16C. In FIG. 16C, the electrode of Example 2 was represented as 98:1:1 (comp.), and the electrode of Comparative Example 1 was represented as Wet ref.

Referring to FIGS. 16A and 16B, it may be seen that the impedance value is smaller in the case of the electrode according to Example 2, and in particular, the charge-transfer resistance (R_{ct}) portion has a significantly lower value than that in the case of Comparative Example 1. Through this, it was confirmed once again that the electrode of Example 2 had a lower resistance value at the interface and that there was no side reaction with the electrolyte. In addition, it may be seen that the ionic resistance of Example 2 has a lower value than that of Comparative Example 1. Through this, it was confirmed once again that the resistance of the electrode of Example 2 manufactured through the dry process was lower than that of the electrode of Comparative Example 1 manufactured through the wet process.

Next, a charge/discharge test of about 150 cycles was performed on the batteries comprising the electrodes of Example 2 and Comparative Example 1. The results were shown in FIG. 17. In FIG. 17, the electrode of Example 2 was represented as 98:1:1_4.0 g/cc_31.23 mg[AM], and the electrode of Comparative Example 1 was represented as Wet ref_96:2:2_3.6 g/cc_32.09 mg[AM]. Here, g/cc was a unit of electrode density, and mg was a unit of loading amount.

Referring to FIG. 17, it may be seen that the capacity retention rate of Example 2 is about 100 mAh cc⁻¹ better than that of Comparative Example 1, and the coulombic efficiency is also about 20% better. Through this, it may be seen that the electrode of Example 2 manufactured through the dry process has better cycle characteristics as well as resistance than the electrode of Comparative Example 1 manufactured through the wet process.

Hereinabove, the present disclosure has been described with reference to preferred examples thereof. It will be understood to those skilled in the art that the present disclosure may be implemented as modified forms without departing from an essential characteristic of the present disclosure. Therefore, the disclosed examples should be considered in an illustrative viewpoint rather than a restrictive viewpoint. The scope of the present disclosure is illustrated by the appended claims rather than by the foregoing description, and all differences within the scope of equivalents thereof should be construed as being comprised in the present disclosure.

1. A method for manufacturing a conductive composite material, the method comprising:
ionizing carbon-based particles to have a first charge; and
ionizing polymer particles to have a second charge opposite to the first charge.

2. The method of claim 1, wherein the carbon-based particles are admixed in a first solvent with a first surfactant, and the polymer particles are admixed in a second solvent with a second surfactant.

3. The method of claim 1, wherein the first charge is a negative charge, and the second charge is a positive charge.

4. The method of claim 2, wherein the first surfactant is an anionic surfactant, and the second surfactant is a cationic surfactant.

5. The method of claim 2, wherein the first surfactant comprises any one selected from the group consisting of ribonucleic acid (RNA), carboxymethyl cellulose (CMC), sodium dodecyl sulfate (SDS), sodium dodecyl benzene sulfonate (SDBS), and a combination thereof, and
wherein the second surfactant comprises any one selected from the group consisting of cetyl trimethyl ammonium bromide (CTAB), dodecyl trimethyl ammonium bromide (DTAB), tetradecyl trimethyl-ammonium bromide (TTAB), and a combination thereof.

6. The method of claim 1, wherein the carbon-based particles comprise carbon nanomaterials, and
wherein the polymer particles comprise fluoropolymers or acrylonitrile-based polymers.

7. The method of claim 2, wherein the first solvent and the second solvent are water or an organic solvent.

8. The method of claim 2, wherein in the first ionization step, the carbon-based particles and the first surfactant are dispersed in a weight ratio of about 1:0.01 to 1:0.5, and
in the second ionization step, the polymer particles and the second surfactant are dispersed in a weight ratio of about 1:0.01 to 1:0.1.

9. The method of claim 2, further comprising:
mixing the first dispersion and the second dispersion to prepare a mixture;
separating a composite product from the mixture; and
drying the composite product.

10. The method of claim 9, wherein in the preparation of the mixture, the carbon-based particles comprised in the first dispersion and the polymer particles comprised in the second dispersion are stirred in a weight ratio of about 0.1:1 to 0.5:1.

11. The method of claim 9, wherein the separating of the composite product is performed by centrifuging at about 3,000 to 5,000 rpm, and
the drying of the composite product is performed at a temperature of about −200 to 200° C.

12. A conductive composite material comprising:
carbon-based particles having a first charge; and
polymer particles having a second charge opposite to the first charge,
wherein the carbon-based particles and the polymer particles form chemical bonds.

13. The conductive composite material of claim 12, wherein the carbon-based particle is surface-modified by the first surfactant to have a first charge, and
wherein the polymer particle is surface-modified by the second surfactant to have a second charge.

14. The conductive composite material of claim 13, wherein the first surfactant is an anionic surfactant, and the second surfactant is a cationic surfactant.

15. The conductive composite material of claim 13, wherein the first surfactant comprises any one selected from the group consisting of ribonucleic acid (RNA), carboxymethyl cellulose (CMC), sodium dodecyl sulfate (SDS), sodium dodecyl benzene sulfonate (SDBS), and a combination thereof, and
wherein the second surfactant comprises any one selected from the group consisting of cetyl trimethyl ammonium bromide (CTAB), dodecyl trimethyl ammonium bromide (DTAB), tetradecyl trimethyl-ammonium bromide (TTAB), and a combination thereof.

16. The conductive composite material of claim 12, wherein the first charge is a negative charge, and the second charge is a positive charge.

17. The conductive composite material of claim 12, wherein the carbon-based particles comprise carbon nanomaterials, and
wherein the polymer particles comprise fluoropolymers or acrylonitrile-based polymers.

18. The conductive composite material of claim 12, wherein the carbon-based particles and the polymer particles are combined in a weight ratio of about 0.1:1 to 0.5:1.

19. A positive electrode for a lithium secondary battery comprising a positive electrode active material; and the conductive composite material of claim 12.

20. The positive electrode of claim 19, wherein the conductive composite material and the positive electrode active material are coated by a dry process.
